(19) United States
(12) Patent Application Publication
(10) Pub. No.: US 2018/0371832 A1
(43) Pub. Date: Dec. 27, 2018

(54) SCREEN ASSEMBLY KIT

(71) Applicant: RCR INTERNATIONAL INC., Boucherville (CA)

(72) Inventors: Tim BROWN, Boucherville (CA); Oscar ARREOLA, Boucherville (CA)

(21) Appl. No.: 16/013,065

(22) Filed: Jun. 20, 2018

Related U.S. Application Data
(60) Provisional application No. 62/522,739, filed on Jun. 21, 2017.

(51) Int. Cl. E06B 9/52

(52) U.S. Cl. CPC E06B 9/52

(57) ABSTRACT

A screen door assembly kit is provided in which all components of the screen door come in a reduced size package, such as a box or bag. The screen assembly kit includes frame members, unions for assembling frame members end to end in linear alignment or in corner alignment to form a rectangular frame, a screen adapted to cover an opening in the rectangular frame, and means for securing the screen to the rectangular frame.

### RELATED APPLICATIONS

This application is a non-provisional application that claims priority benefit to U.S. Provisional Application Ser. No. 62/522,739 filed Jun. 21, 2017; the contents of which are hereby incorporated by reference.

### TECHNICAL FIELD

The present application relates to screens such as sliding screen doors and, more particularly, to a screen door assembly kit or screen assembly kit.

### BACKGROUND OF THE ART

Replacement screen doors are commonly available due to the fragility of original screen doors. Indeed, screen doors feature extended and slender frame members that hold a screen taut, and such frame members have been known to break over time. However, replacement screen doors have the problem of being voluminous, with the problems that come with such large products: issues in storage, packaging, difficulty in handling and displacing, etc. Often, consumers must purchase such screen doors and have to plan some way to carry them home, which may result in damages to the screen door. Moreover, protective packaging may end up being extensive due to the size of the screen doors.

### SUMMARY

It is therefore an aim of the present disclosure to provide a screen door assembly kit by which all components of the screen door come in a reduced size package, such as a box or bag.

In accordance with the present disclosure, there is provided a screen assembly kit includes: frame members; unions for assembling frame members end to end in linear alignment or in corner alignment to form a rectangular frame; a screen adapted to cover an opening in the rectangular frame; and means for securing the screen to the rectangular frame.

### DESCRIPTION OF THE DRAWINGS

FIG. 1 is a perspective view of a screen door as assembled from a screen door assembly kit in accordance with the present disclosure; and

FIG. 2 is an exploded view of a frame of the screen door assembly kit of FIG. 1.

### DETAILED DESCRIPTION

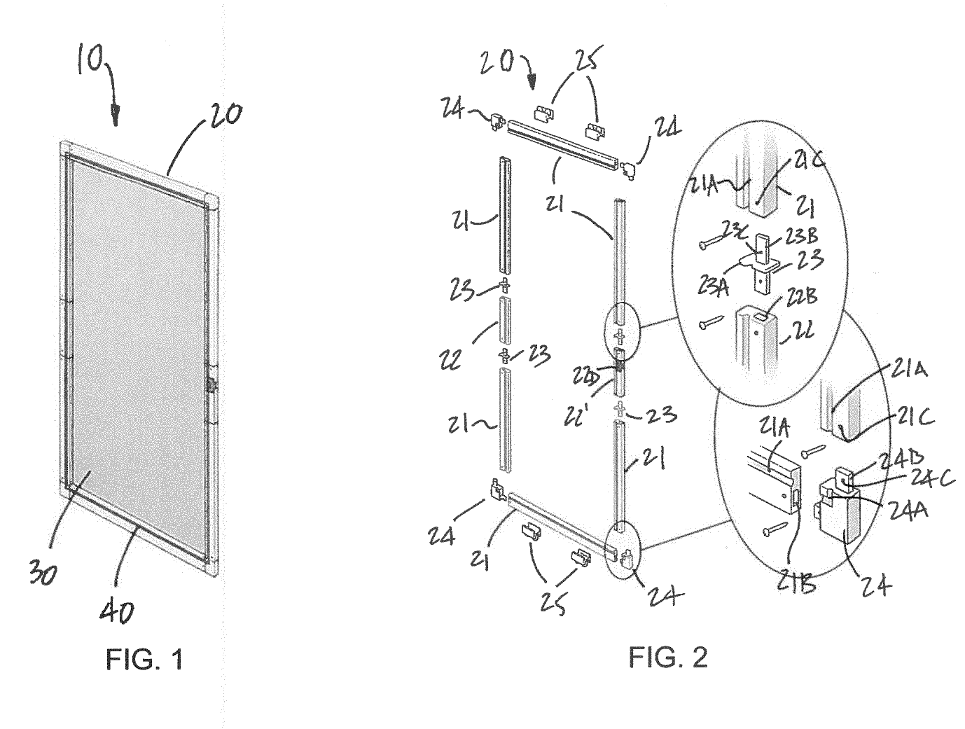

Referring to the drawings and, more particularly, to FIGS. 1 and 2, a screen door in accordance with the present disclosure is generally shown at 10, as assembled. The screen door is of the type that blocks an opening, such as a door opening, to prevent insect penetration through opening, while allowing air circulation therethrough. All components of the screen door assembly kit enabling the assembly into the screen door 10 are present in FIG. 1. The screen door 10 has:
A frame 20 being the structure of the screen door 10 and the support for the mesh screen 30. The frame 20 is interfaced to a structure of a dwelling defining the opening, such as door rails on a door sill, a hinge of door jambs, etc.
The mesh screen 30 may also be known as a mosquito net, screen, mesh, among other names. The mesh screen 30 may be made of polypropylene, or any other material including metal.
A bead 40 secures the mesh screen 30 to the frame 20 in a taut condition, as in FIG. 1. The bead 40 peripherally surrounds the mesh screen 30, and is typically made of a resilient or rubbery material, that will elastically deform or squeeze to hold the screen 30 captive against a surface of a channel of the frame 20, as described herein. The bead 40 may be made of PVC or any other appropriate rubbery material. Other means that may be used as an alternative include glue, tape, a U-shaped elongated clip, etc.

Reference is made herein to a screen door. However, it is contemplated to use the screen assembly kit for window screens as well, or for any type or door, including sliding doors (a.k.a., patio doors), hinged doors, etc. For simplicity, reference is made herein to a screen door, but the disclosure may include a use of the screen assembly kit for other types of openings than door openings.

Referring to FIG. 2, the frame 20 is shown in greater detail. For ease of inventory, the frame 20 may be constituted of a limited number of pieces. As an example, the frame 20 may have six frame members 21 as in FIG. 2, each having the same length. Moreover, each of the frame members 21 may be identical. The frame 20 may also have a pair of shorter frame members 22, with one of the frame members 22 illustrated as 22′ and being the one supporting a locking mechanism, of a locking mechanism is present. The frame 20 may have four linear unions 23 to connect the frame members 21 to the frame members 22, or to connect the frame members 21 to one another. The frame 20 may also have four corner unions 24 to connect the frame members 21 that are vertical in the frame 20 to frame members 22 that are horizontal in the frame 20. Therefore, as observed from FIGS. 1 and 2, each horizontal frame member 21 has a pair of the corner unions 24 at its ends. Wheel assemblies 25 may also be provided, with the frame 20 shown as having four wheel assemblies 25. As an alternative, hinge members or hinges may be provided if the screen door 10 is to be hinged to a door jamb. In other instances, the frame 20 does not have wheel assemblies 25 or hinges. For example, if the screen of the assembly kit is to be used for a window, such components may not be necessary.

The above number of parts is given as an exemplary embodiment. However, the number of these components may vary in any appropriate manner. As a non-exhaustive example, instead of having shorter frame members 22, the frame members 21 may be longer to be cut to an appropriate size. Moreover, although not detailed, fasteners such as screws may be used and are illustrated in FIG. 2. As an example, the kit has four frame members 21 and not frame members 22, or one or more long frame members 21 to be cut to appropriate lengths.

Still referring to FIG. 2, one of the frame members 21 is detailed. The frame member 21 has a channel 21A extending from end to end of the frame member 21. At its end faces, the frame member 21 has a socket or bore 21B, acting as a female connector portion. Fastener hole 21C is aligned with the socket 21B such a fastener fitted into the fastener hole 21C penetrates the socket 21B. All of the frame members 21 may have a similar configuration. The socket 21B may extend from end to end of the frame member 21 (i.e., defining a through-channel), being the result of the manufacturing of the frame member 21. According to an embodiment, the frame member 21 is extruded, and thus results from an extrusion process. The frame member 21 may be fabricated in any other appropriate way (cast, molded, pultruded, etc). The frame member 21 is typically made of aluminum or other metal, although polymers and composites may be used as well.

The frame members 22 have a similar configuration with the same cross-section as the frame members 21, and therefore the method of manufacturing, materials, etc, may be the same. The frame members 22 are shorter than the frame members 21. The frame members 22 also have a channel, shown as 22A, a socket shown as 22B (e.g., a through-channel) and holes shown as 22C, for the same reasons as the channels, sockets and holes 21A, 21B, and 21C, respectively, of the frame members 21. It is observed that the frame member 22′ differs from the frame member 22 as it has a locking mechanism 22D by which the screen door may be locked to the structure of the dwelling.

The linear unions 23 are configured for assembly of the frame members 21 with the frame members 22, or of the frame members 21 together in an embodiment without frame members 22. Therefore, although not necessary for the frame 20, the frame members 21 could also be connected end-to-end by the linear unions 23. Hence, the linear unions 23 are arranged to interconnect the frame members end-to-end in linear fashion. The linear unions 23 have a flange 23A from which project male connectors 23B. The male connectors 23B are sized so as to be snugly received in the sockets 21B and 22B of the frame members 21 and 22, respectively. It is observed that the flange 23A also defines a groove that will be aligned with the channels 21A and 22A to form a continuous channel in spite of the linear union 23 separating the channels 21A and 22A. This channel will be sized to receive the bead 40 therein. The linear unions 23 also have holes 23C that are aligned with the holes 21C and 22C for receiving the fasteners and therefore allowing the assembly of the frame members 21, 22 with the linear unions 23. It is pointed out that the frame members 21, 22 and the linear unions 23 may be without such holes 23C, but these holes have the advantage of being precisely positioned to ensure the parts are well screwed or fastened to one another.

Corner unions 24 have a similar configuration as the linear unions 23, but are angled at 90 degrees to allow corners to be made between pairs of the frame members 21. As observed from the FIG. 2, corner unions 24 have a channel 24A that defines a bend. Accordingly, when the frame 20 is assembled in the manner shown in FIG. 1, a continuous channel is formed by the concurrent alignment of channels 21A, 22A, 24A and the slot in the flange 23A. The corner unions 24 also have male connectors 24B that are to be received in the sockets 21B of the frame members 21. Finally, holes 24C may also be provided for fasteners to be used.

In order to assemble the frame 20, the frame members 21 and 22 are disposed in the manner shown in FIG. 2, with the appropriate union 23 or 24 therebetween. It is contemplated to fit the male connectors 23B and 24B in the sockets 21B and 22B, to form the frame 20. The friction between the male connectors 23B and 24B and the surfaces of the sockets 21B and 22B may suffice in keeping the frame 20 together, and glue may also be used. In another embodiment, the fasteners are then inserted in the holes 21C, 22C, 23C and 24C. The frame 20 is therefore assembled.

The mesh screen 30 may then be laid onto the frame 20, to cover the rectangular opening defined by the frame 20. A continuous string of bead 40 may then be inserted in the peripheral continuous channel defined in the frame 20, i.e., the peripheral continuous channel concurrently defined by channels 21A, 22A, 24A and the slot in the flange 23A. The bead 40 may be slightly larger in cross-section than the channel, to elastic deform when squeezed therein. Accordingly, the mesh screen 30 is held captive to the frame 20 by the biasing action of the bead 40. As an alternative to a single bead 40, the kit may come with segments of bead 40. Wheel assemblies 25 may simply be clipped on to the horizontal frame members 21 and feature rollers that are to be received in rails to allow the sliding movement of the screen door 10. The wheel assemblies 25 are typically made of nylon and bearings may be present.

Because of the segmenting of the frame 20 in frame members 21 and 22, the screen door 10 may be put in a box or a bag, or such small package, as a screen door assembly kit. It is therefore an efficient storage solution that is easy to transport and assemble. It may be required to cut the frame members 21 to an appropriate length, although the screen door assembly kits may come in different sizes based on the size of the openings.

Although the frame 20 has been described as having hollow frame members 21 and 22 (or with sockets 21B and 22B), for male connectors 23B and 24B in the unions 23 and 24, the reverse arrangement is contemplated as well.

1. A screen assembly kit comprising:
frame members;
unions for assembling frame members end to end in linear alignment or in corner alignment to form a rectangular frame;
a screen adapted to cover an opening in the rectangular frame; and
means for securing the screen to the rectangular frame.

2. The screen assembly kit according to claim 1, wherein the frame members and unions concurrently define a continuous channel surrounding the opening in the rectangular frame, and
wherein the means is at least one bead received in the continuous channel

3. The screen assembly kit according to claim 1, comprising six frame members of a first length, two frame members of a second length, four unions allowing end to end linear alignment and four unions allowing corner alignment.
